(19) United States
(12) Patent Application Publication
(10) Pub. No.: US 2018/0269603 A1
(43) Pub. Date: Sep. 20, 2018

(54) PLUG-IN CONNECTOR

(71) Applicant: DIEHL METAL APPLICATIONS GMBH, BERLIN (DE)

(72) Inventor: UWE ZEIGMEISTER, TELTOW (DE)

(21) Appl. No.: 15/893,105

(22) Filed: Feb. 9, 2018

(30) Foreign Application Priority Data
Mar. 14, 2017 (DE) 10 2017 002 472.3

(51) Int. Cl. H01R 4/62; H01R 12/58

(52) U.S. Cl. CPC H01R 4/62; H01R 12/58

(57) ABSTRACT

A plug-in connector has a press-in body which is coated with a first Ni-containing layer and a second Ni-containing layer. The first and/or the second Ni-containing layer is a nanocrystalline or amorphous layer. The first Ni-containing layer and the second Ni-containing layer have grain sizes of different orders of magnitude. In particular, one of the layers can be microcrystalline and the other can be nanocrystalline or amorphous.

### CROSS-REFERENCE TO RELATED APPLICATION

This application claims the benefit, under 35 U.S.C. § 119, of German patent application DE 10 2017 002 472.3, filed Mar. 14, 2017; the prior application is herewith incorporated by reference in its entirety.

### BACKGROUND OF THE INVENTION

### Field of the Invention

The invention relates to a plug-in connector.

A plug-in connector which is suitable for being inserted or pressed into a hole in a circuit board is known, for example, from published, non-prosecuted German patent application DE 10 2008 042 824 A1. The plug-in connector has an approximately cylindrical region in which a plug-in connector inserted in a circuit board establishes electrical contact with the circuit board, which region will hereinafter be referred to as contact region. The conventional plug-in connector has a press-in body which can be made of copper, bronze or CuSn₆. The press-in body is coated with two layers which are arranged at least partly on top of one another, with the outer layer containing thiol. The thiol serves as passivating agent or lubricant in order to limit the pressing-in force required during pressing in. The disadvantage of this plug-in connector is that an organic intermediate layer, which adversely affects the electrical properties, is necessary in the contact region.

### SUMMARY OF THE INVENTION

It is an object of the present invention to overcome the disadvantages of the prior art. In particular, a plug-in connector which can be pressed into a circuit board using low pressing-in forces and is simple to produce should be provided.

According to the invention, a plug-in connector containing a press-in body which is coated with a first Ni-containing layer and a second Ni-containing layer, wherein the first and/or the second Ni-containing layer is a nanocrystalline or amorphous layer, is provided.

The first Ni-containing layer and the second Ni-containing layer have grain sizes of different orders of magnitude. In particular, one of the layers can be microcrystalline and the other can be nanocrystalline or amorphous. For the purposes of the present invention, “microcrystalline” means a grain size in the range from 0.3 μm to 7 μm, in particular from 0.5 μm to 3 μm. For the purposes of the present invention, “nanocrystalline” means a grain size of from 4 nm to 200 nm, in particular from 4 nm to 100 nm, in particular from 4 nm to 80 nm, in particular from 4 nm to 60 nm. For the purposes of the present invention, “amorphous” means that no crystallites are detectable by means of conventional methods such as X-ray diffraction, electron diffraction or transmission electron microscopy.

In particular, the Ni-containing layers do not contain any appreciable amounts of organic impurities. The Ni-containing layers advantageously contain at least 80% by weight, in particular at least 90% by weight, of nickel. The Ni-containing layers particularly preferably contain at least 95% by weight, in particular at least 97% by weight, of nickel. The first and second Ni-containing layers are at least partly superposed, and they are preferably superposed over their full area.

The advantage of the plug-in connector of the invention is that it can be coated by means of electrochemical coating, e.g. strip electroplating. Separate coating by means of an organic auxiliary is not necessary. The plug-in connector of the invention thus does not have any organic coating, particularly in the contact region in which it is contacted with the circuit board on pressing into a circuit board.

In an advantageous embodiment, one of the Ni-containing layers is a matt nickel and the other Ni-containing layer is bright nickel. For the purposes of the present invention, a bright nickel is a nickel coating which has a smooth, shiny surface. A matt nickel has a matt, i.e. relatively rough, surface. Known electrolytes are used for producing a bright nickel or a matt nickel.

In a further embodiment, the first or the second Ni-containing layer of the plug-in connector of the invention is an amorphous layer which contains up to 15% by weight of phosphorus, in particular up to 10% by weight of phosphorus. The amorphous Ni-containing layer can be stabilized by the addition of phosphorus.

The nanocrystalline and/or amorphous layer preferably has a thickness of from 0.1 to 3 μm, in particular from 0.1 to 2.2 μm, in particular from 0.1 to 1 μm, in particular from 0.1 to 0.7 μm, in particular from 0.1 to 0.3 μm. The layer sequence on the press-in body can, in particular, be selected from among the layer sequences indicated in Table I:

TABLE I

| First Ni-containing | Second Ni-containing | Third Ni-containing |
|---|---|---|
| layer | layer | layer |
| amorphous | Nanocrystalline | |
| amorphous | Microcrystalline | |
| nanocrystalline | Amorphous | |
| nanocrystalline | Microcrystalline | |
| microcrystalline | amorphous | |
| microcrystalline | nanocrystalline | |
| nanocrystalline | microcrystalline | amorphous |
| nanocrystalline | microcrystalline | nanocrystalline |
| microcrystalline | nanocrystalline | amorphous |

In a preferred embodiment, the press-in body of the plug-in connector of the invention contains copper, a copper alloy or steel. In particular, the copper alloy can be an alloy composed of CuFe, FuFe₂P, CuNiSn, CuNiSi, CuZn, CuSnZn, CuSn₄, CuSn₆ or CuSn₈.

In a further embodiment, an intermediate layer composed of Cu or Sn can be arranged between the press-in body and the first Ni-containing layer. The surface roughness can be reduced further by the intermediate layer.

Other features which are considered as characteristic for the invention are set forth in the appended claims.

Although the invention is illustrated and described herein as embodied in a plug-in connector, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a plug-in connector according to the invention;

FIG. 2 is a diagrammatic, sectional view of a coating sequence of the plug-in connector of FIG. 1;

FIG. 3 is a sectional view of a second working example of a layer sequence of the coating of the plug-in connector;

FIG. 4 is a sectional view of a third working example of the coating sequence of a plug-in connector;

FIG. 5 is a sectional view of a fourth working example of a coating of a plug-in connector;

FIG. 6 is a graph showing a friction test;

FIG. 7 is a further graph of the friction test;

FIG. 8 is a schematic depiction of a transmission electron micrograph of a cross section of a bright nickel surface; and

FIG. 9 is a schematic depiction of a transmission electron micrograph of a cross section of an amorphous NiP surface.

### DETAILED DESCRIPTION OF THE INVENTION

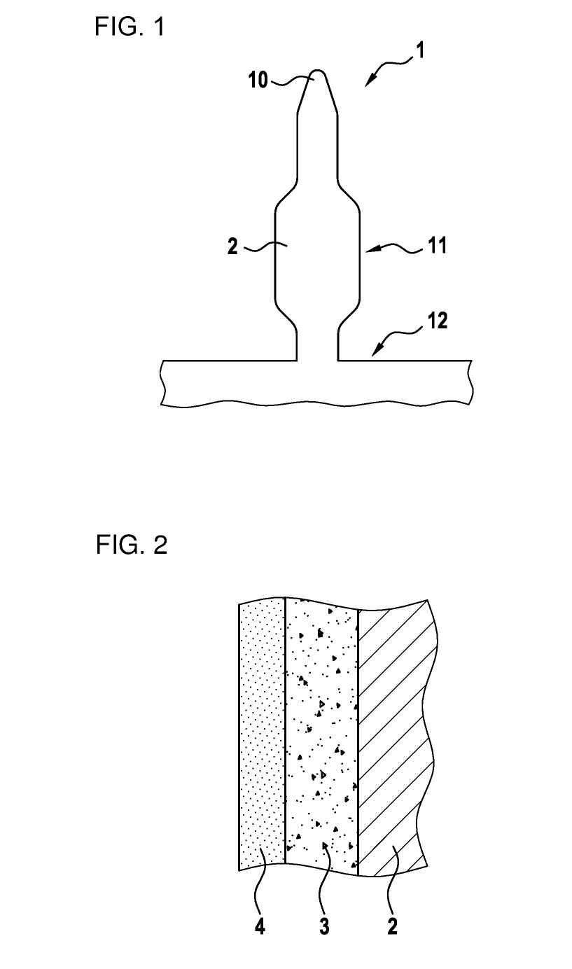

Referring now to the figures of the drawings in detail and first, particularly to FIG. 1 thereof, there is shown a plug-in connector 1 which is suitable for pressing into an opening of a circuit board which is made of copper and is coated with bronze and/or tin. The plug-in connector 1 contains a pin tip 10, a press-in body 2 having a press-in region 11 and a fastening region 12. The plug-in connector 1 is coated with two Ni-containing layers which are at least partly superposed. A cylindrical section of the press-in region 11 serves as contact area.

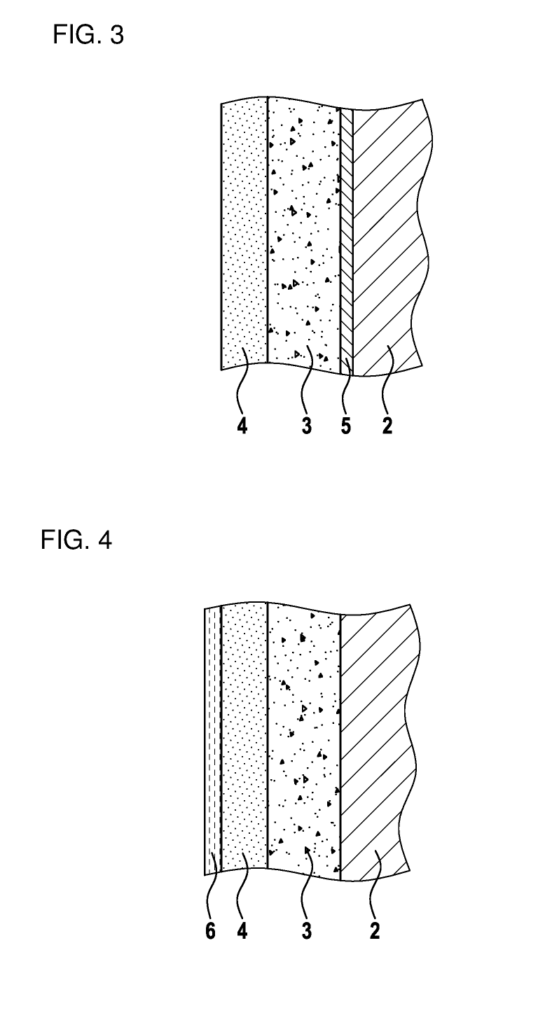

FIG. 2 shows a first working example of the layer structure of the plug-in connector 1. The press-in body 2 is made of CuSn₆ and has a roughness Ra=0.5 μm. A first Ni-containing layer 3 having an average grain size of 0.8 μm is arranged on top of this. The final surface is formed by a nanocrystalline second Ni-containing layer 4 which has an average grain size of 30 nm. The second Ni-containing layer 4 having a nanocrystalline grain size increases the surface hardness, which at a grain size of 30 nm has an E modulus of 205+/−7 GPa and an indentation hardness of 9.4+/−0.6 GPa. The nanocrystalline microstructure of the second Ni-containing layer 4 produces a smoother surface which has improved sliding properties. Such a layer sequence is particularly suitable for a one-off plug-in operation.

FIG. 3 shows a further working example of a layer structure of a plug-in connector. The layer structure has an intermediate layer 5 between the press-in body 2 and the first Ni-containing layer 3. The intermediate layer 5 consists of tin. It serves as a bonding layer and also for evening out the roughness of the press-in body 2. The intermediate layer is a nanocrystalline layer having a grain size of 30 nm. As an alternative, the intermediate layer 5 can also consist of copper.

FIG. 4 shows a third working example of a layer structure on a press-in body 2 having three Ni-containing layers, where the first Ni-containing layer 3 is a nanocrystalline layer, the second Ni-containing layer 4 is a microcrystalline layer and the third Ni-containing layer 6 is an amorphous layer. The amorphous layer contains 12% by weight of phosphorus. Such an Ni—P layer has an E modulus of 149+1-6 GPa and an indentation hardness of 9+1-0.7 GPa. The surface of the amorphous layer has a constant low frictional resistance against a copper contact surface. Cold welding against a copper or bronze layer can be minimized or prevented by means of such a layer structure. The amorphous layer has increased stability against frictional oxidation and low layer degradation, so that it is also well-suited to repeated plugging-in operations.

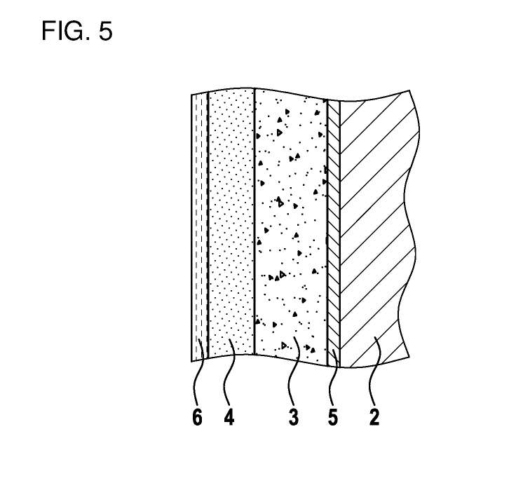

FIG. 5 shows a layer structure on a press-in body 2 having three Ni-containing layers and also an intermediate layer 5. The three Ni-containing layers 3, 4, 6 correspond to those of the working example shown in FIG. 4. The intermediate layer 5 consists of tin.

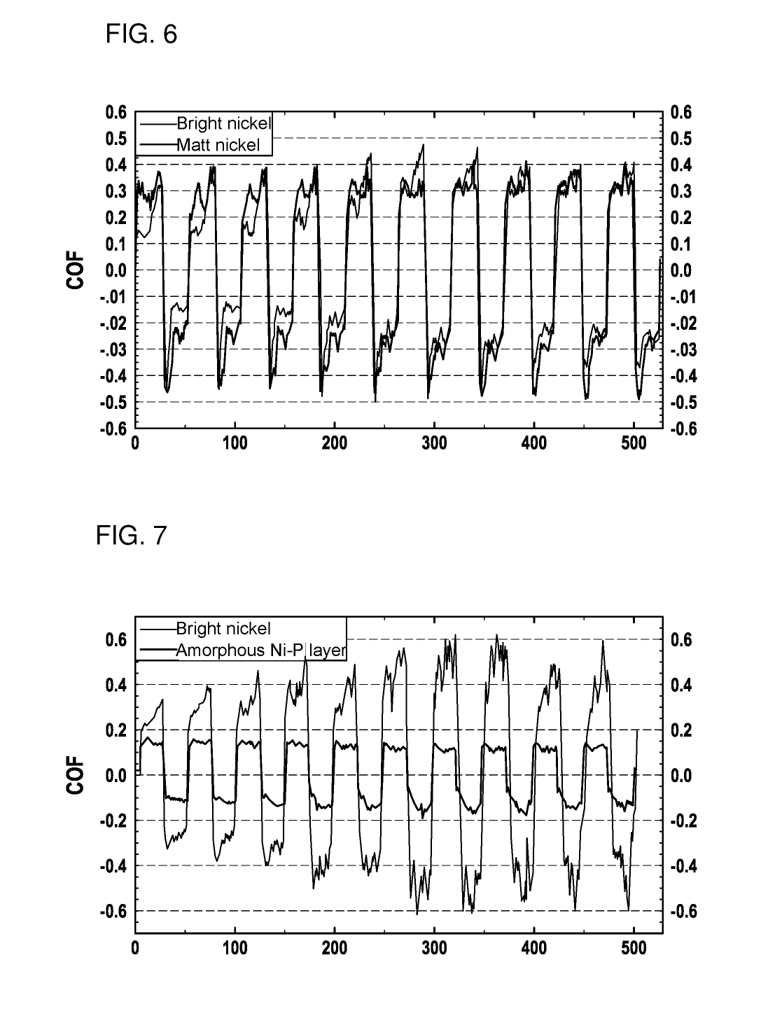

FIG. 6 shows the result of two friction tests between a copper pin and a plate coated with a matt nickel or a bright nickel, respectively. The time is plotted on the horizontal axis, and the coefficient of friction (COF) is plotted on the vertical axis. The curve for the bright nickel shows a running-in phase in which the coefficient of friction increases during the friction test, while the coefficient of friction has an approximately constant value in the friction test on matt nickel.

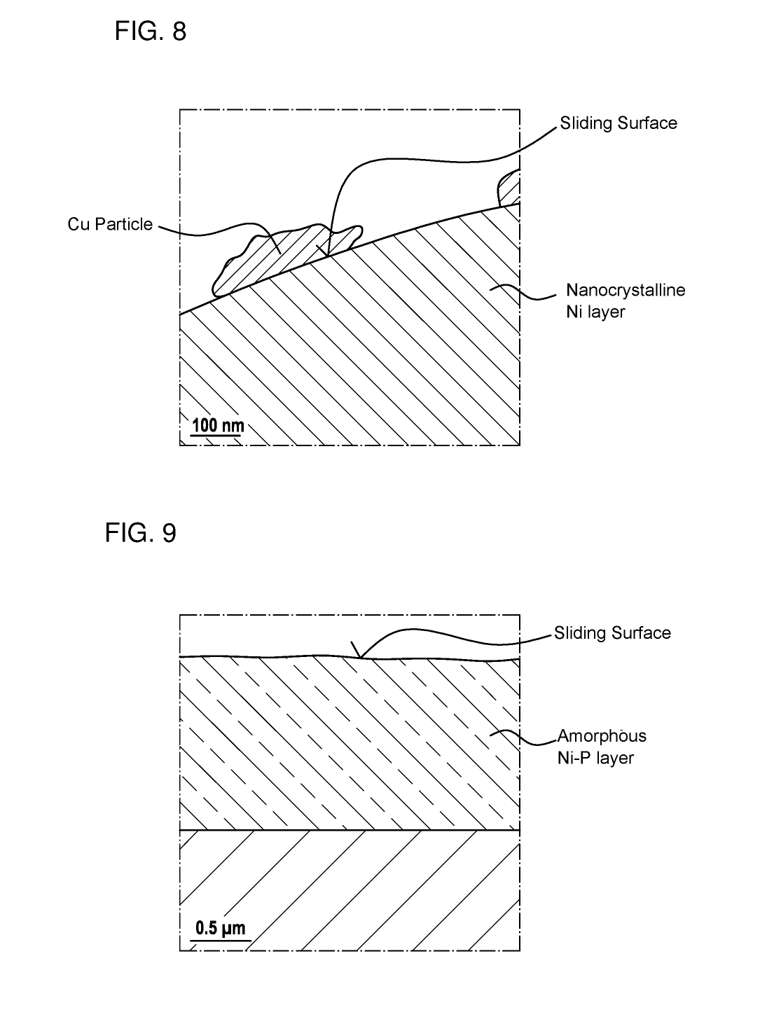

FIG. 7 is a graph and shows a comparison of a further friction test between a copper pin and a plate coated with bright nickel or an amorphous Ni—P layer. The friction tests on the amorphous Ni—P layer show a constant low coefficient of friction, while the friction test on the bright nickel displays an increasing coefficient of friction. After 10 friction cycles, a transfer of Cu particles, as can be seen in the schematic depiction of the microscopic examination in FIG. 8, occurs in the case of bright nickel. In the case of an amorphous Ni—P layer, no transfer of material to the friction surface, as is shown in FIG. 9, was observed after 10 friction cycles.

The following is a summary list of reference numerals and the corresponding structure used in the above description of the invention:
1 Plug-in contact
2 Press-in body
3 First Ni-containing layer
4 Second Ni-containing layer
5 Intermediate layer
6 Third Ni-containing layer
10 Pin tip
11 Press-in region
12 Fastening region

1. A plug-in connector, comprising:
a press-in body;
a first Ni-containing layer coating said press-in body; and
a second Ni-containing layer coating said press-in body, at least one of said first Ni-containing layer or said second Ni-containing layer is a nanocrystalline layer or an amorphous layer.

2. The plug-in connector according to claim 1, wherein one of said first and second Ni-containing layers is a matt nickel and another of said first and second Ni-containing layers is a bright nickel.

3. The plug-in connector according to claim 1, wherein said first Ni-containing layer or said second Ni-containing layer is said amorphous layer which contains up to 15% by weight of phosphorus.

4. The plug-in connector according to claim 1, wherein at least one of said nanocrystalline layer or said amorphous layer has a thickness of 0.1-3 μm.

5. The plug-in connector according to claim 1, further comprising a third Ni-containing layer disposed on top of said second Ni-containing layer.

6. The plug-in connector according to claim 5 wherein said second Ni-containing layer is microcrystalline and said third Ni-containing layer is said nanocrystalline or said amorphous.

7. The plug-in connector according to claim 1, wherein said press-in body is formed of a material selected from the group consisting of copper, a copper alloy and steel.

8. The plug-in connector according to claim 7, wherein said copper alloy is an alloy composed of CuFe, FuFe₂P, CuNiSn, CuNiSi, CuZn, CuSnZn, CuSn₄, CuSn₆ or CuSn₈.

9. The plug-in connector according to claim 1, further comprising an intermediate layer composed of Cu or Sn and disposed between said press-in body and said first Ni-containing layer.

10. The plug-in connector according to claim 1, wherein said first Ni-containing layer or said second Ni-containing layer is said amorphous layer which contains up to 10% by weight of phosphorus.

11. The plug-in connector according to claim 1, wherein at least one of said nanocrystalline layer or said amorphous layer has a thickness of 0.1-2.2 μm.

12. The plug-in connector according to claim 1, wherein at least one of said nanocrystalline layer or said amorphous layer has a thickness of 0.1-1 μm.

13. The plug-in connector according to claim 1, wherein at least one of said nanocrystalline layer or said amorphous layer has a thickness of 0.1-0.7 μm.

14. The plug-in connector according to claim 1, wherein at least one of said nanocrystalline layer or said amorphous layer has a thickness of 0.1-0.3 μm.
